(19) United States
(12) Patent Application Publication
(10) Pub. No.: US 2009/0096984 A1
(43) Pub. Date: Apr. 16, 2009

(54) COMBINED SUNGLASSES AND OPENER

(76) Inventors: Robert Philip IANELLI, Hopewell Junction, NY (US); Rhett Morgan ROBERTS, Wayzata, MN (US)

Correspondence Address: HESLIN ROTHENBERG FARLEY & MESITI PC, 5 COLUMBIA CIRCLE, ALBANY, NY, 12203, US

(21) Appl. No.: 12/243,462

(22) Filed: Oct. 1, 2008

Related U.S. Application Data
(60) Provisional application No. 60/998,569, filed on Oct. 12, 2007.

(51) Int. Cl. G02C 11/00

(52) U.S. Cl. 351/158

(57) ABSTRACT

Sunglasses have a frame with a front section containing lenses, and, temple bars having proximal portions hinged to the frame and distal end portions, at least one of the temple bars provided with an opener, preferably at the temple bar distal end portion.

### CROSS-REFERENCE TO RELATED APPLICATION

The present application is related to Provisional Application Ser. No. 60/998,569 filed Oct. 12, 2007. This prior application is incorporated herein by this reference and the benefit of its filing date is claimed herein as well.

### BACKGROUND OF THE INVENTION

1. Field of the Invention

This invention relates to a combined sunglasses and opener unit.

2. Description of the Prior Art

It is known that glasses have been provided that have a utilitarian purpose in addition to their normal function as an aid in vision. So far as known, no one has suggested or taught the combination of sunglasses with an opener.

### SUMMARY

An object of the invention is the provision of sunglasses that not only protect the eyes from the sun, but also provide a further utility function as well.

These and other objects, features and advantages are accomplished in accordance with the teachings of the present invention, one illustrative embodiment of which comprises sunglasses having a frame with a front section containing lenses, and, temple bars having proximal portions hinged to the frame and distal end portions. at least one of the temple bars is provided with an opener, preferably at the temple bar distal end portion.

### BRIEF DESCRIPTION OF THE DRAWINGS

Other objects, features and advantages of the present invention will be apparent from the following detailed description and accompany drawing, wherein:

FIG. 1 is a side view of the combined sunglasses and opener of the present invention, with an opener at the distal end of the temple bar;

FIG. 2 is a side view of the opener of FIG. 1;

FIG. 3 is a perspective view of a portion of a temple piece of the sunglasses of FIG. 1 with its opener;

FIG. 4 is a perspective view of the combined sunglasses-opener of FIG. 1;

FIG. 5 is a front view of the combined sunglasses-opener of FIG. 1;

FIG. 6 is a top view of the combined sunglasses opener of FIG. 1;

FIG. 7 is a side view of an alternate embodiment of the combined sunglasses and opener of the present invention, with an opener at the approximate mid-point of the temple bar;

FIG. 8 is a side view of the opener of FIG. 7;

FIG. 9 is a perspective view of a portion of a temple piece of the sunglasses of FIG. 7 with its opener;

FIG. 10 is a perspective view of the combined sunglasses-opener of FIG. 7;

FIG. 11 is a side view of an alternate embodiment of the combined sunglasses and opener of the present invention, with an opener at the proximal end of the temple bar;

FIG. 12 is a side view of the opener of FIG. 11;

FIG. 13 is a perspective view of a portion of a temple piece of the sunglasses of FIG. 11 with its opener; and,

FIG. 14 is a perspective view of the combined sunglasses-opener of FIG. 11.

### DETAILED DESCRIPTION

Referring now to the drawing there is shown a sunglass frame 10 with front section 11 and sunglass lenses 12. The frame 10 is made of a rugged injection molded material such as high end industry standard plastic. This material is both strong so as to withstand the tension and torque of opening a bottle, but lightweight as well. The frame and arms may also be made of, but not limited to, metal, graphite, wood, polymer, carbon fiber and ceramic.

At each end of the front section 11 is provided a temple bar 13, hinged at its proximal end to the frame 10. The distal end of the temple bar 13 is curved inwardly. An opener 14 is provided having a shank portion 15 molded within and integral with the temple bar 13 and prying means 16 made to simulate the appearance of the distal end of the temple bar 13. The opener 14 is rounded off at its top end and curved, in alignment with the temple bar 13 and may be made of such materials, but not limited to, as metal, carbon fiber, etc. The temple bar 13 and opener 14 may also be made of the same material and formed or molded as one piece.

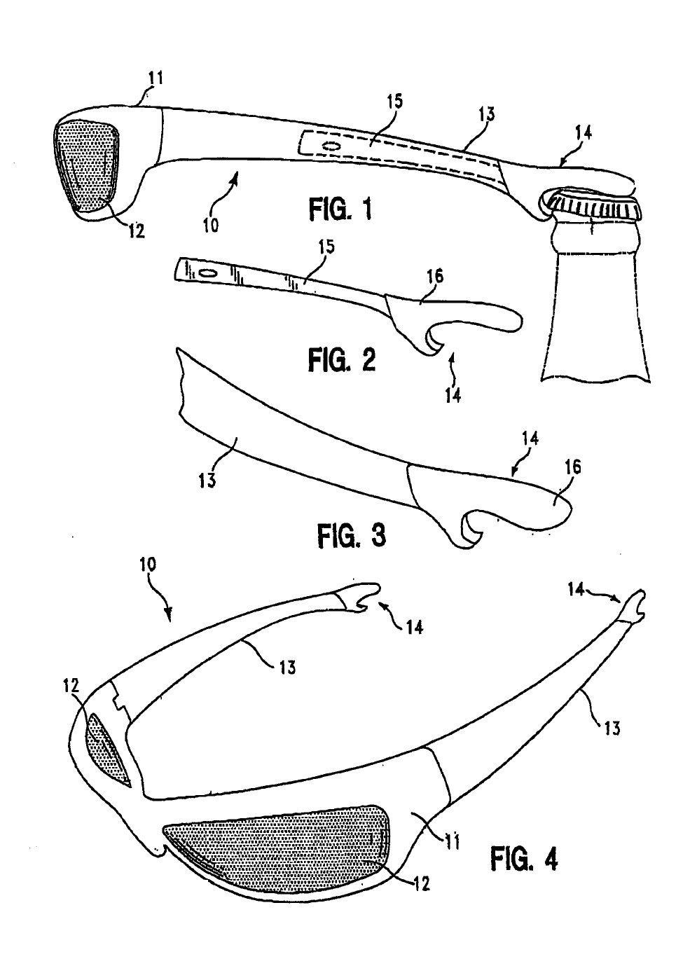

The opener 14 can be used at any time to pry open products that have a standard cap, as, for example, by prying off the cap of a bottle in the manner shown in FIG. 1 of the drawing, by raising the temple bar 13.

Since the user is wearing the sunglasses, there is little likelihood of misplacing the opener, a very common problem.

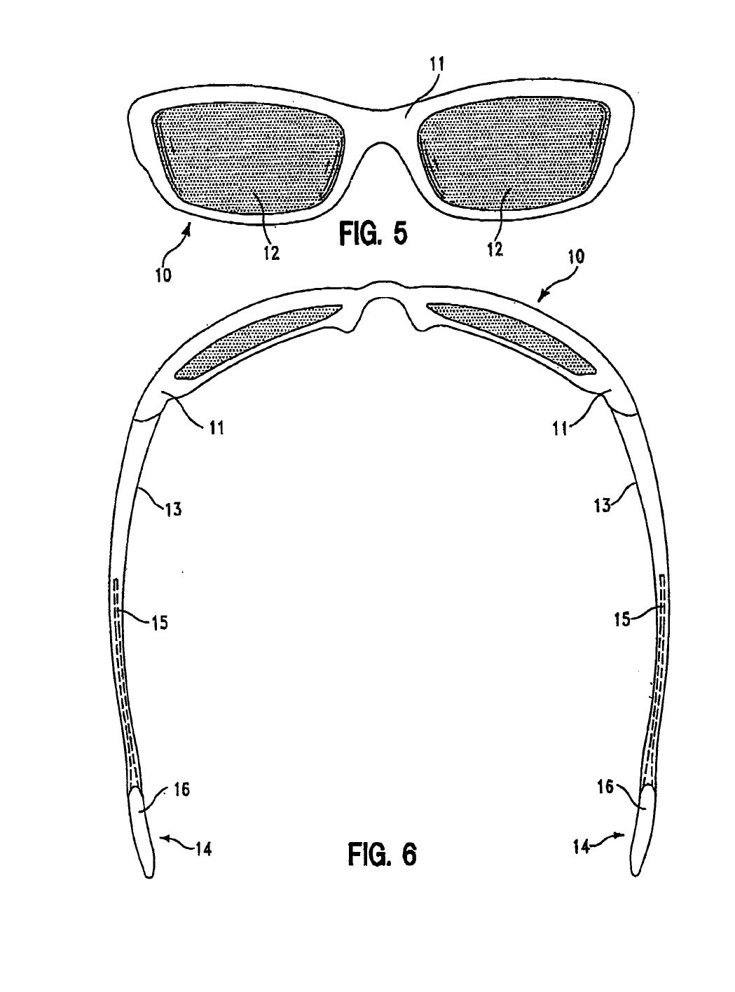

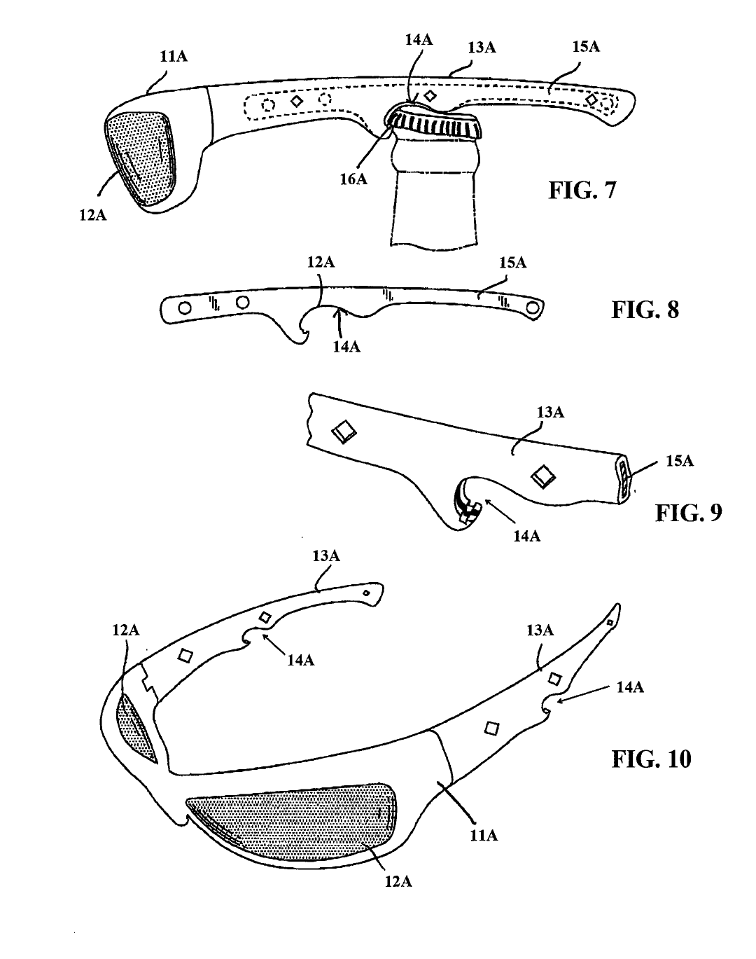

FIGS. 7 through 10 show a first alternate embodiment of the present invention wherein comparable parts to those found in FIGS. 1 through 6 are given the same reference numeral plus the letter A and wherein the opener 14A is found in the approximate mid-portion of the temple bar 13A.

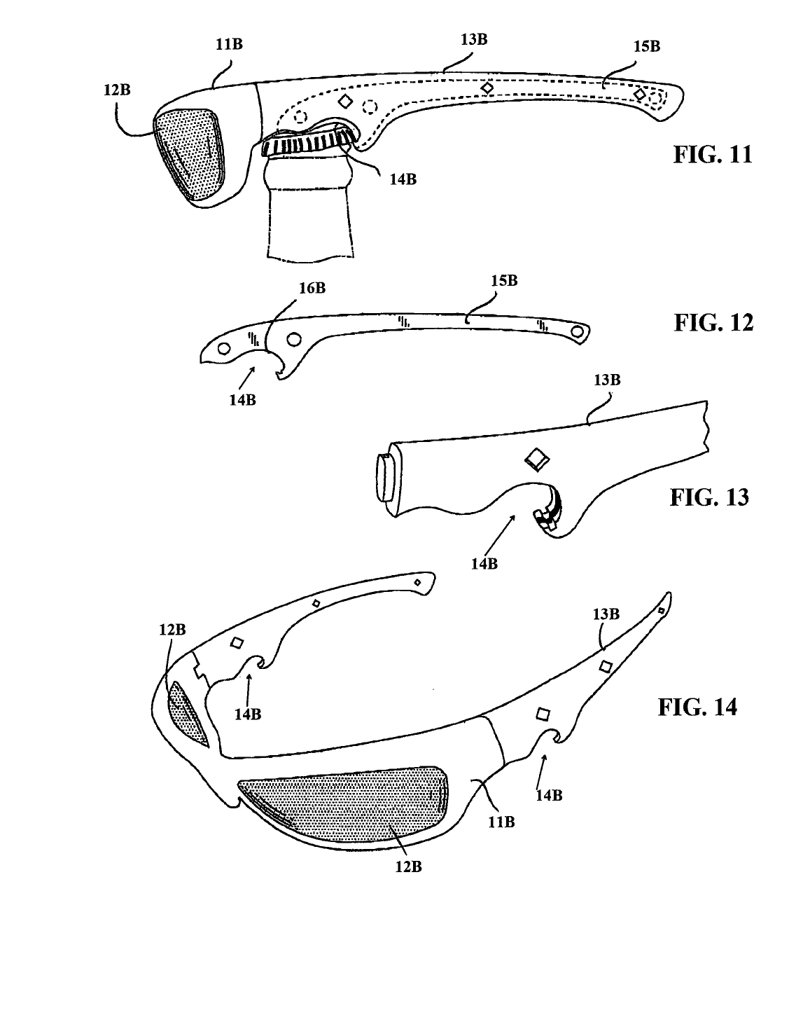

FIGS. 11 through 14 show a second alternate embodiment of the present invention wherein comparable parts to those found in FIGS. 1 through 6 are given the same reference numeral plus the letter B and wherein the opener 14B is found in the proximal end of the temple bar 13B.

It should be obvious that changes, additions and omissions may be made in the details and arrangement of parts without departing from the spirit and scope of the invention as hereinafter claimed.

What is claimed is:

1. Sunglasses having
a frame with a front section containing lenses, and,
temple bars having proximal portions hinged to the frame and distal end portions,
at least one of the temple bars provided with an opener for removing a cap from a bottle.

2. The sunglasses of claim 1 wherein the opener is provided at the temple bar distal end portion.

3. The sunglasses of claim 1 wherein the opener is provided approximately midway between the proximal and distal end of the temple bar.

4. The sunglasses of claim wherein the opener is provided at the temple bar proximal portion.
